(19) United States
(12) Patent Application Publication
(10) Pub. No.: US 2016/0226953 A1
(43) Pub. Date: Aug. 4, 2016

(54) DEVICE MANAGEMENT APPARATUS, RELAY APPARATUS, RELAY METHOD, AND COMPUTER READABLE MEDIUM

(71) Applicant: FUJI XEROX CO., LTD., Tokyo (JP)

(72) Inventors: Shigeki ISHINO, Yokohama-shi (JP); Masamune OSHITANI, Tokyo (JP); Takahiro OKAYASU, Sagamihara-shi (JP); Teppei AOKI, Kamakura-shi (JP); Shinichiro YAMAMOTO, Kawasaki-shi (JP); Bryan WOOD, Aloha, OR (US); John KAYE, Newberg, OR (US); Russell NEVILLE, Portland, OR (US)

(73) Assignee: FUJI XEROX CO., LTD., Tokyo (JP)

(21) Appl. No.: 14/657,257

(22) Filed: Mar. 13, 2015

(30) Foreign Application Priority Data
Jan. 29, 2015 (JP) 2015-015439

(51) Int. Cl. H04L 29/08

(52) U.S. Cl. CPC H04L 67/10; H04L 67/06

(57) ABSTRACT

A device management system includes: a management apparatus including a first memory unit that stores a control program for controlling a management target device, for each type of the management target device; and a relay apparatus including an acquisition unit that acquires the control program corresponding to a type of the management target device connected to the relay apparatus from the management apparatus, and an execution unit that executes a process for supplying the control program acquired by the acquisition unit to a control device connected to the relay apparatus, the control device controlling the management target device connected to the relay apparatus.

### CROSS-REFERENCE TO RELATED APPLICATIONS

This application is based on and claims priority under 35 USC 119 from Japanese Patent Application No. 2015-015439 filed on Jan. 29, 2015.

### BACKGROUND

1. Technical Field

The present invention relates to a device management apparatus, a relay apparatus, a relay method, and a computer readable medium.

2. Related Art

In a case of installing a device driver for controlling a device such as a printer in a device such as a personal computer (PC), in general, the device driver is acquired from a management apparatus such as a management server storing the device driver and installed in the device such as the PC. For example, the device driver is installed in the device such as the PC by a user accessing a web page that provides the device driver by using the device such as the PC and selecting a device driver for a target device out of plural device drivers on the web page.

### SUMMARY

An aspect of the present invention provides a device management system including: a management apparatus including a first memory unit that stores a control program for controlling a management target device, for each type of the management target device; and a relay apparatus including an acquisition unit that acquires the control program corresponding to a type of the management target device connected to the relay apparatus from the management apparatus, and an execution unit that executes a process for supplying the control program acquired by the acquisition unit to a control device connected to the relay apparatus, the control device controlling the management target device connected to the relay apparatus.

### BRIEF DESCRIPTION OF THE DRAWINGS

Exemplary embodiment(s) of the present invention will be described in detail based on the following figures, wherein:

FIG. 1 is a block diagram illustrating an example of a device management system according to an embodiment of the present invention;

FIG. 2 is a block diagram illustrating an example of a management apparatus according to the present embodiment;

FIG. 3 is a diagram illustrating an example of a printer driver management table stored in the management apparatus;

FIG. 4 is a block diagram illustrating an example of a relay apparatus according to the present embodiment;

FIG. 5 is a diagram illustrating an example of a terminal device management table stored in the relay apparatus;

FIG. 6 is a diagram illustrating an example of a printer driver management table stored in the relay apparatus;

FIG. 7 is a flowchart illustrating an example of a process by the relay apparatus;

FIG. 8 is a sequence diagram illustrating an example of a process by the device management system;

FIG. 9 is a diagram illustrating an example of a screen of the terminal device;

FIG. 10 is a flowchart illustrating an example of a process by the relay apparatus; and

FIG. 11 is a diagram illustrating an example of a terminal device management table according to a modification.

### DETAILED DESCRIPTION

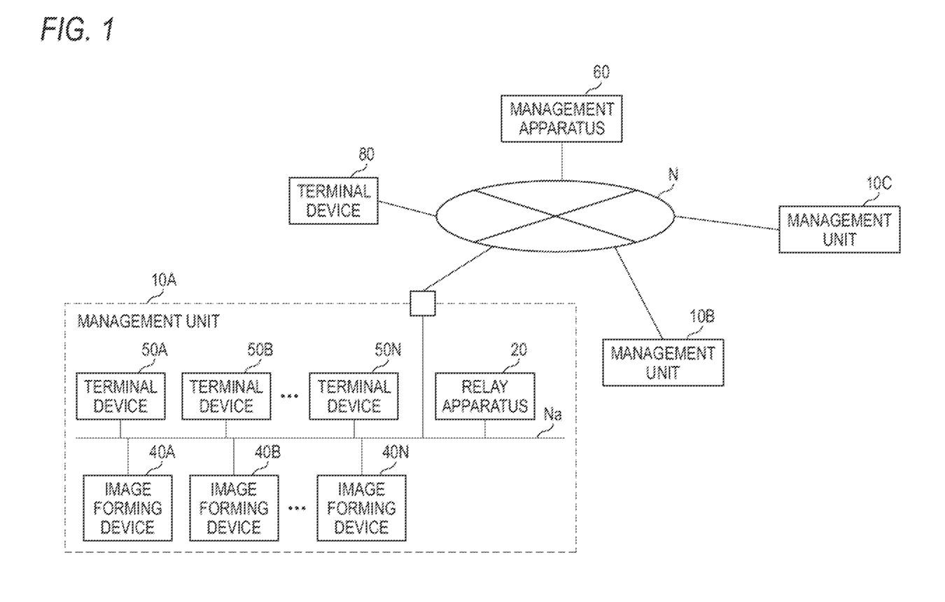

FIG. 1 illustrates an example of a device management system according to an embodiment of the present invention. The device management system includes a single or plural management units 10 (as an example, management units 10A, 10B, and 10C), and a management apparatus 60 provided outside the management unit 10. In addition, if there is no need to distinguish between the management units 10A, 10B, and 10C, they are referred to as “a management unit 10”. The plural management units 10 and the management apparatus 60 are connected to a communication path N. The communication path N includes, for example, a network such as the Internet. Further, a terminal device 80 may be connected to the communication path N. In addition, in the example illustrated in FIG. 1, although three management units 10 are included in the device management system, it is only an example, and one management unit 10 or four or more management units 10 may be included in the device management system. Further, plural terminal devices 80 may be connected to the communication path N. A server such as a print server may be connected to the communication path N.

The management runt 10 is an array of a computer and other devices. The array may be an organization of users utilizing the devices. The devices have a function of communicating data through a communication path Na such as a local area network (LAN) or an intranet. The management unit 10 is, for example, one office, factory, home, or the like.

The management unit 10 includes a relay apparatus 20, a single or plural image forming devices 40 (as an example, image forming devices 40A, 40B, . . . , 40N), and a single or plural terminal devices 50 (as an example, terminal devices 50A, 50B, . . . , 50N). In addition, if there is no need to distinguish between the image forming devices 40A, 40B, . . . , 40N, they are referred to as “an image forming device 40”. The plural image forming devices 40 are connected to the communication path Na. In the example illustrated in FIG. 1, although the plural image forming device 40 are included in the management unit 10, it is only an example, and one image forming device 40 may be included in the management unit 10. Further, if there is no need to distinguish between the terminal devices 50A, 50B, . . . , 50N, they are referred to as “a terminal device 50”. The plural terminal devices 50 are connected to the communication path Na. In the example illustrated in FIG. 1, although the plural terminal devices 50 are included in the management unit 10, it is only an example, and one terminal device 50 may be included in the management unit 10.

The communication path Na may be either a wired system or a wireless system, or a combination thereof. The communication path Na is connected to the communication path N, for example, through a firewall, a gateway, or the like.

The image forming device 40 is an example of a device to be managed (management target device) by the device management system. The image forming device 40 is, for example, a printer, a complex machine (a multifunction device equipped with a copy function, a printing function, a scanning function, and the like), a scanner, a facsimile, or the like. Various types (for example, various models or specifications) of image forming devices 40 can be connected to the communication path Na. For example, plural image forming devices 40 which have been manufactured by the same manufacturer may be connected to the communication path Na, and plural image forming devices 40 which have been manufactured by different manufacturers may be connected to the communication path Na. There are cases where plural image forming devices 40 which have been manufactured by the same manufacturer include various models of image forming devices 40. Further, there are cases where plural image forming devices 40 of the same model include various specifications of image forming devices 40. In the present embodiment, the image forming device 40 corresponds to the management target device, but a device other than the image forming device 40 may correspond to the management target device.

The terminal device 50 is, for example, a device such as a personal computer, a mobile phone, a smartphone, or a tablet terminal. The terminal device 50 has a function of using the image forming device 40 through the communication path Na.

The relay apparatus 20 has a function of receiving, firmware for each image forming device 40, a device driver such as a printer driver, and updated version data of the device driver, from the management apparatus 60. The device driver is a program for allowing the terminal device 50 to use to control the management target device. The printer driver is a control program for allowing the terminal device 50 to control the image forming device 40. The relay apparatus 20 stores the firmware and the device driver so as to install them in the respective corresponding image forming device 40 and the terminal device 50. Further, the relay apparatus 20 may have a function of collecting, device information used for managing each image forming device 40, from each image forming device 40 connected to the communication path Na, and supplying the device information to the management apparatus 60.

It is also conceivable to install a program describing a function of the relay apparatus 20 in a certain terminal device 50 connected to the communication path Na, and use the terminal device 50 as the relay apparatus 20. However, in the present embodiment, as an example, the relay apparatus 20 which is designed as a dedicated device is used in view of the convenience of operation and the robustness of the device itself. The relay apparatus 20 which is a dedicated device may have a performance of executing a limited program necessary for the device management system. Thus, the hardware performance of the relay apparatus 20 (a CPU performance, a memory capacity, and the like) may not be so high. The relay apparatus 20 may be made as a relatively small and inexpensive device. Further, the relay apparatus 20 may not include a function of performing an unspecified program which is not expected in advance. Therefore, since failure is less likely to occur, there is basically no need for the user to perform maintenance of the relay apparatus 20, and the number of times of maintenance is reduced. Further, the supply of information to the user side is performed by the management apparatus 60 through the communication path N. Therefore, the relay apparatus 20 may not be equipped with a UI unit (user interface unit) such as a display screen or an input device.

The management apparatus 60 collects the device information regarding each image forming device 40 through the communication path N from the relay apparatus 20 in each management unit 10, and supplies services to each management unit 10 by using the device information. In the present embodiment, the management apparatus 60 has a function of storing a printer driver and supplying the printer driver to the management unit 10. The management apparatus 60 may be a single server device, or a system including plural computers such as a cloud computing system. An example of the services provided by the management apparatus 60 includes a service of supplying information collected by the management unit 10 (for example, the state, usage, and the like of each image forming device 40) and secondary information obtained by analyzing the information to the administrator of the management unit 10. For example, it is assumed that the administrator of a certain management unit 10 can log in to the management apparatus 60 by using the terminal device 80 and can browse the information regarding the management unit 10. In addition, the terminal device 80 is a device such as a personal computer, a mobile phone, a smartphone, or a tablet terminal. Further, the management apparatus 60 may provide one or more services out of management of charging for the use of the image forming device 40, management of the remaining amount of consumables of each image forming device 40, distribution of the latest version of a device driver and firmware, and setting of various types of setting information for the image forming device 40. Of course, these are merely examples, and the management apparatus 60 may also provide other various services using the collected information.

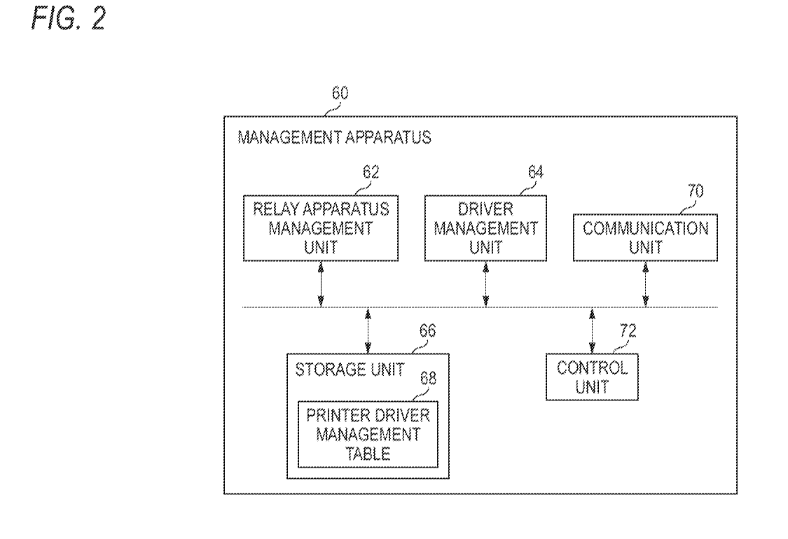

FIG. 2 illustrates a configuration of the management apparatus 60.

The relay apparatus management unit 62 manages information regarding each management unit 10. For example, the relay apparatus management unit 62 manages relay apparatus identification information (for example, a relay apparatus ID) for identifying the relay apparatus 20 of each management unit 10, the device information regarding the image forming device 40 in each management unit 10, and the like. Further, the relay apparatus management unit 62 may manage the information of the administrator of each management unit 10 (for example, the user ID of the administrator, and the like). The information is stored in the storage unit 66. For example, the user ID (administrator ID) of the administrator who manages the relay apparatus 20, the name (for example, a group name) of the management unit 10 in which the relay apparatus 20 is provided, and the device information regarding the image forming device 40 in the management unit 10 are stored in the storage unit 66, in association with the relay apparatus ID of each relay apparatus 20. For example, the e-mail address of the administrator may be used as the administrator ID. The device information includes, for example, device identification information (for example, a device ID, a device name, and the like) for identifying the image forming device 40, device model information (for example, a model name, and the like) indicating the model of the image forming device 40, usage history information indicating the usage history of the image forming device 40, operation state information indicating an operation state (for example, a normal state, an out-of-toner state, and the like) of the image forming device 40, and the like. The usage history information is information indicating a date and time when, for example, the image forming device 40 is used (for example, a print date and time, and the like), the number of outputs at the time of each use (for example, a count value indicating the number of prints), and the like. Of course, other information may be included in the usage history information.

The driver management unit 64 stores a device driver such as a printer driver in the storage unit 66, and manages the device driver. For example, if a new device driver or the updated version of the device driver is generated and supplied to the management apparatus 60, the driver management unit 64 stores the new device driver and the updated version of the device driver in the storage unit 66. Further, the driver management unit 64 driver identification information for identifying the printer driver stored in the storage unit 66 (for example, a driver ID and name, and the like), device model information indicating the model of the image forming device controlled by the printer driver (for example, a model name, and the like), and OS information (for example, an OS name) indicating an operating system (OS) corresponding to the printer driver are associated with each other. The driver management unit 64 creates a printer driver management table 68 representing the association. The printer driver management table 68 is stored in the storage unit 66. The printer driver may be automatically supplied, for example, from the manufacturer of the image forming device 40 to the management apparatus 60, or may be supplied to the management apparatus 60 by an administrator or the like.

The storage unit 66 is a storage device such as a hard disk. The storage unit 66 stores a device driver, a printer driver management table 68, and information (a relay apparatus ID, device information, and the like) managed by the relay apparatus management unit 62. Further, the storage unit 66 stores address information of the relay apparatus 20 for communicating with the relay apparatus 20.

The communication unit 70 is a communication interface connected to the communication path N. The communication unit 70 has a function of receiving data from other devices and a function of transmitting data to other devices. The control unit 72 controls the operation of each unit of the management apparatus 60. In addition, the management apparatus 60 may be equipped with a UI unit.

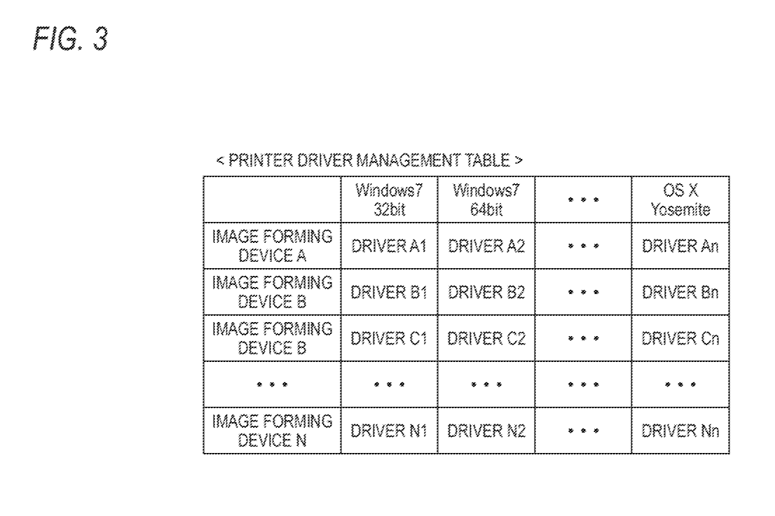

FIG. 3 illustrates an example of the printer driver management table 68. As an example, a model name, an OS name, and driver identification information (for example, an driver ID) of an image forming device are associated with each other. For example, a driver A1 is a printer driver for OS “Windows (registered trademark) 7 (32 bit version)” for controlling an image forming device of which the model name is “image forming device A”.

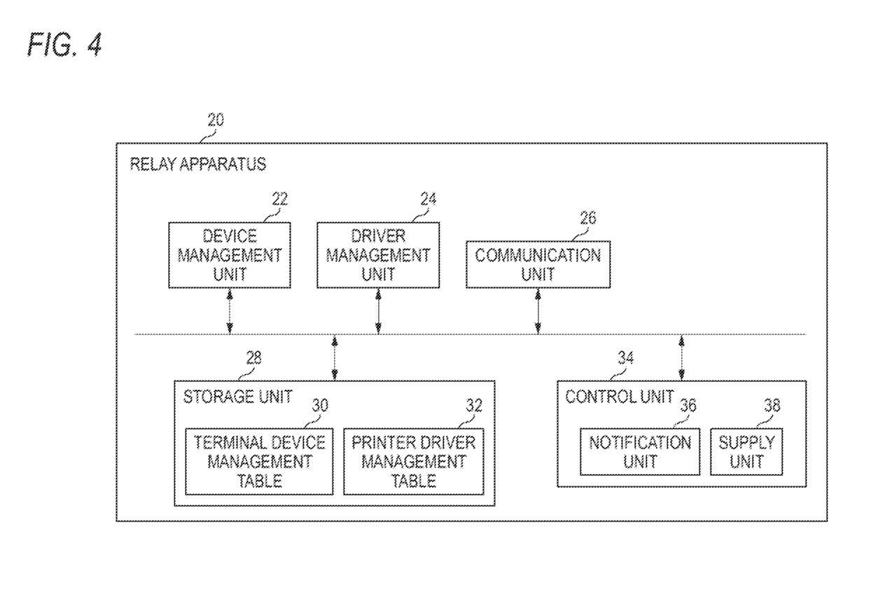

FIG. 4 illustrates a configuration of the relay apparatus 20.

The device management unit 22 acquires device information regarding each image forming device 40 connected to the communication path Na and terminal information regarding each terminal device 50 connected to the communication path Na, and manages the device information and the terminal information. The device information and the terminal information are stored in the storage unit 28. The terminal information contains, for example, terminal device identification information for identifying the terminal device 50 (for example, a terminal device ID), terminal device model information indicating the model of the terminal device 50 (for example, a model name), OS information indicating an OS installed in the terminal device 50 (for example, an OS name), state information, and the like.

For example, the device management unit 22 manages the type of the OS installed in each terminal device 50, and the type of the image forming device 40 that can be used by each terminal device 50 (the image forming device 40 connected to each terminal device 50). The device management unit 22 associates terminal device identification information for identifying each terminal device 50 (for example, a terminal device ID), OS information indicating the OS installed in each terminal device 50 (for example, an OS name), and device information regarding the image forming device 40 that can be used by each terminal device 50 with each other. The device management unit 22 creates a terminal device management table 30 representing the association. The terminal device management table 30 is stored in the storage unit 28.

Further, the device management unit 22 manages the type of the printer driver associated with each image forming device 40 (the type of the printer driver required for using each image forming device 40). The device management unit 22 creates a printer driver management table 32 representing the printer driver associated with each image forming device 40. The printer driver management table 32 is stored in the storage unit 28.

The driver management unit 24 acquires the printer driver from the management apparatus 60, and stores the acquired printer driver in the storage unit 28. The driver management unit 24 manages driver identification information for identifying the printer driver stored in the storage unit 28 (for example, a driver ID and name, and the like), and device model information indicating the model of the image forming device 40 controlled by the printer driver (for example, a model name and the like) in association with each other. The driver management unit 24 acquires the printer driver corresponding to the type (for example, a model and a specification) of each image forming device 40 connected to the communication path Na, from the management apparatus 60. For example, when a new printer driver corresponding to the model of the image forming device 40 connected to the communication path Na is stored in the management apparatus 60, the driver management unit 24 acquires the new printer driver from the management apparatus 60. The printer driver acquired in this manner is stored in the storage unit 28.

The communication unit 26 is a communication interface, and has a function of being connected to the communication path N and the communication path Na. The communication unit 26 has a function of receiving data from other devices and a function of transmitting data to other devices.

Device information, terminal information, and a device driver acquired by the driver management unit 24 are stored in the storage unit 28. Further, a terminal device management table 30 and a printer driver management table 32 are stored in the storage unit 28.

The control unit 34 controls the operation of each unit of the relay apparatus 20. Further, the control unit 34 includes a notification unit 36 and a supply unit 38.

The notification unit 36 transmits information indicating that the driver management unit 24 has newly acquired a printer driver, to the terminal device 50 connected to the communication path Na. For example, when the terminal device 50 having an OS corresponding to the printer driver acquired by the driver management unit 24 mounted therein is connected to the communication path Na, the notification unit 36 transmits the information to the terminal device 50. Further, when a new terminal device 50 is connected to the communication path Na, if the printer driver corresponding to the OS installed in the new terminal device 50 is stored in the storage unit 28, the notification unit 36 transmits information indicating the presence of the printer driver, to the new terminal device 50.

The supply unit 38 transmits the printer driver to the terminal device 50, in response to an acquisition request for a printer driver from the terminal device 50. Thus, the printer driver is installed in the terminal device 50.

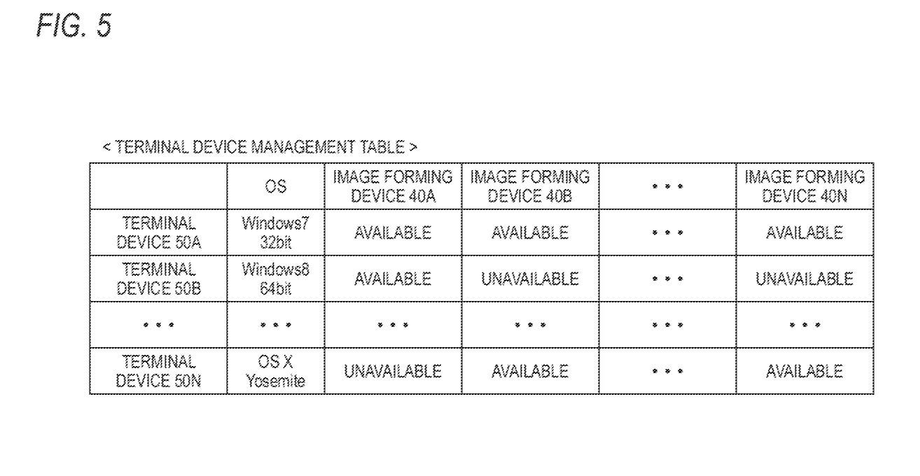

FIG. 5 illustrates an example of the terminal device management table 30. As an example, terminal device identification information of each terminal device 50 (for example, a terminal device ID), the name of OS installed in each terminal device 50, and device identification information of the image forming device 40 that can be used by each terminal device 50 (for example, a device ID and a device name) are associated with each other. For example, the OS installed in the terminal device 50A is “Windows (registered trademark) 7 (32 bit version)”. The image forming devices that can be used by the terminal device 50A (image forming devices connected to the terminal device 50A) are image forming devices 40A, 40B, . . . , 40N. Further, the OS installed in the terminal device 50B is “Windows (registered trademark) 8 (64 bit version)”. The image forming device that can be used by the terminal device 50B is the image forming device 40A. In addition, the terminal device management table 30 may be generated through a manual operation by a user such as the administrator. The terminal device management table 30 may be stored in the management apparatus 60.

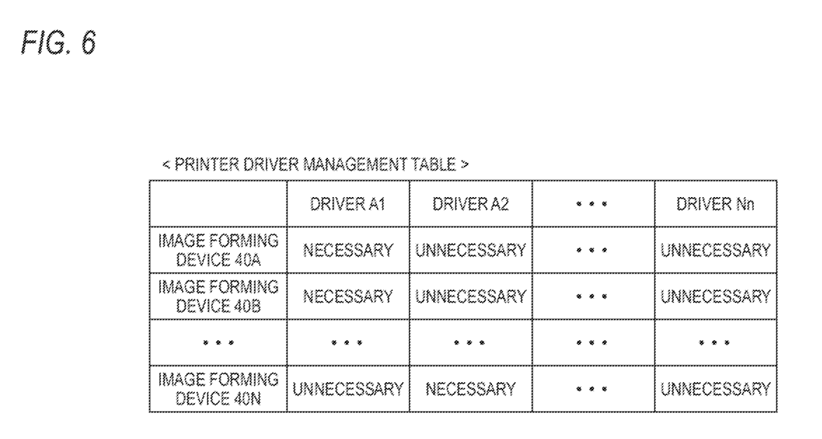

FIG. 6 illustrates an example of the printer driver management table 32. As an example, driver identification information of the printer driver required for using each image forming device 40 (for example, a driver ID and name, and the like), and device identification information of the image forming device 40 controlled by the printer driver (for example, a device ID and a device name) are associated with each other. For example, the printer driver required for using the image forming devices 40A and 40B is “driver A1”. Further, the printer driver required for using the image forming device 40N is “driver A2”. In addition, the printer driver management table 32 may be generated through a manual operation by a user such as the administrator. The printer driver management table 32 may be stored in the management apparatus 60.

Here, a registration process by the relay apparatus 20 to the management apparatus 60 will be described. The relay apparatus 20 corresponds to a protocol for remote management of devices from the management apparatus 60. The relay apparatus 20 has a function of communicating with the management apparatus 60 by using the protocol. As such a protocol for remote management, for example. TR-069 is known. Of course, a protocol other than this protocol may be used. The relay apparatus 20 stores information indicating the address of the management apparatus 60. If a communication session is established between the relay apparatus 20 and the management apparatus 60, the relay apparatus 20 notifies the management apparatus 60 of identification information of the relay apparatus 20, in other words, a relay apparatus ID, through the communication path N. Thus, the relay apparatus 20 is registered in the management apparatus 60.

Next, an acquisition process of the device information and the terminal information by the relay apparatus 20 will be described. For example, the device management unit 22 transmits a request for acquiring device information to the image forming device 40 connected to the communication path Na, and transmits a request for acquiring terminal information to each terminal device 50 connected to the communication path Na. In the acquisition request process, for example, the relay apparatus 20 multicasts or broadcasts a packet to the communication path Na. The device management unit 22 identifies individual devices on the communication path Na, based on the packets that are returned from the individual devices on the communication path Na in response to the packets. The packet that is returned from each device contains the type and address of the device. In addition, the device management unit 22 may receive a reply packet from other devices (for example, a household electrical appliance, and the like) on the communication path Na, and manage the other devices.

If each image forming device 40 and each terminal device 50 on the communication path Na are recognized, the device management unit 22 makes a request for device information to each image forming device 40. Further, the device management unit 22 makes a request for terminal information to each terminal device 50. These requests are made, by using, for example, a simple network management protocol (SNMP).

Each image forming device 40 transmits its own device information to the relay apparatus 20. For example, each image forming device 40 includes a database termed a management information base (MIB), holds its own device information in the MIB, and updates the contents depending on a change in its own state (for example, an increase in the number of printed sheets). The image forming device 40 returns the device information in the MIB, to the relay apparatus 20, in response to the acquisition request from the relay apparatus 20. The device management unit 22 stores the device information acquired from each image forming device 40 in the storage unit 28. Further, each terminal device 50 transmits its own terminal information to the relay apparatus 20, in response to the acquisition request from the relay apparatus 20. The device management unit 22 stores the terminal information acquired from each terminal device 50 in the storage unit 28.

The relay apparatus 20 transmits the device information regarding each image forming device 40 to the management apparatus 60. Here, the relay apparatus 20 may transmit the device information in association with its own relay apparatus ID.

The relay apparatus management unit 62 of the management apparatus 60 stores the device information regarding each image forming device 40 that has been acquired from the relay apparatus 20 in the storage unit 66, in association with the relay apparatus ID. Thus, each image forming device 40 included in each management unit 10 is registered in the management apparatus 60. In this manner, the management apparatus 60 recognizes the name and the model name of each image forming device 40 present on the same communication path Na as in the relay apparatus 20, and registers the information. Further, when information such as usage history and the device state is contained in the device information regarding each image forming device 40 transmitted from the relay apparatus 20, the information is also stored in the storage unit 66 of the management apparatus 60.

Through the above process, the relay apparatus 20 provided in the management unit 10 is registered in the management apparatus 60, in association with the administrator. After the registration, if the administrator logs in to the management apparatus 60, the administrator can browse the states of each image forming device 40 in the management unit 10.

The relay apparatus 20 periodically acquires, for example, device information from the image forming device 40, and acquires terminal information from each terminal device 50. Further, each image forming device 40 may transmit information indicating the occurrence of a predetermined event to the relay apparatus 20, if the event occurs. The event to be reported includes a change in the state of consumables such as being out-of-paper or out-of-toner, the occurrence of a failure in the image forming device 40, and the like. The relay apparatus 20 transmits the information collected from each image forming device 40 in this manner to the management apparatus 60, autonomously or in response to the request from the management apparatus 60.

The management apparatus 60 may have a function of performing the setting of the image forming device 40 on the same communication path Na as in the relay apparatus 20 through the relay apparatus 20 that has been registered, or updating the setting thereof. The information such as the device information or the setting information regarding the image forming device 40 is stored, for example, in the MIB held by the image forming device 40. The management apparatus 60 updates the collection and setting of the state information, by performing reading and writing to the MIB through the relay apparatus 20.

Further, the management apparatus 60 may have a function of updating the firmware of the relay apparatus 20 by using the protocol for remote management. When detecting the update of the firmware of a certain image forming device 40 in the management unit 10, the management apparatus 60 may acquire the updated version data, and update the firmware of the image forming device 40 through the relay apparatus 20 in the management unit 10 with the updated version data. In this case, the management apparatus 60 transmits the updated version data to the relay apparatus 20 using the protocol for remote management, and the relay apparatus 20 stores the received updated version data. The relay apparatus 20 may install the stored updated version data in the corresponding image forming device 40 in a push method, or transmit the updated version data in response to a download request from the corresponding image forming device 40. In the latter case, for example, the management apparatus 60 provides information indicating the update of the firmware of the image forming device 40, to the administrator of the management unit 10. For example, the information is displayed on the web page for the administrator. If the administrator who receives the information operates the image forming device 40, the updated version data is downloaded from the relay apparatus 20 to the image forming device 40, and installed in the image forming device 40.

The management apparatus 60 may generate a screen (for example, a web page) displaying information regarding each image forming device 40 which is collected through the relay apparatus 20 and information obtained by processing the information. If the administrator logs in to the management apparatus 60 from the terminal device 80, a screen displaying such information may be provided in the terminal device 80. For example, the name, the model name, the usage history, the version of the present installed firmware, and the like of the image forming device 40 are displayed on the terminal device 80. Further, a user interface (UI) for instructing the stopping and resuming of the use of the image forming device 40 may be provided in the terminal device 80. If the administrator operates the UI, the state of the image forming device 40 may be set to a use stopped state or a use state. For example, the instructions of stopping and resuming are transferred to the image forming device 40 through the relay apparatus 20 from the management apparatus 60.

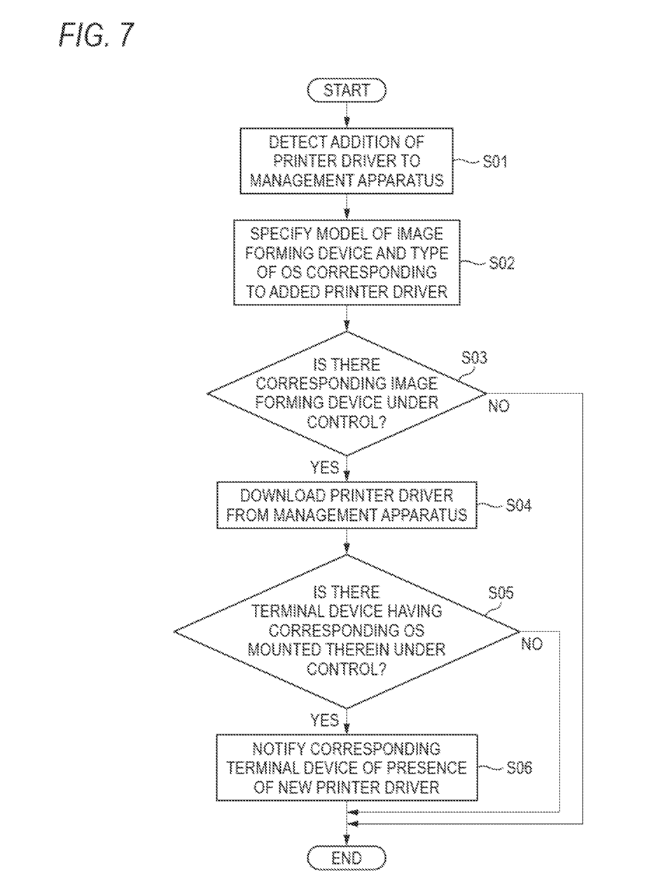

Next, the process by the relay apparatus 20 when a new printer driver is registered in the management apparatus 60 will be described with reference to FIG. 7.

First, if a new printer driver is registered in the management apparatus 60, the driver management unit 24 of the relay apparatus 20 detects the registration (S01). For example, the driver management unit 64 of the management apparatus 60 transmits information indicating the registration of the new printer driver to the relay apparatus 20. The driver management unit 24 of the relay apparatus 20 detects the registration of the new printer driver by receiving the information. As another example, the registration of the new printer driver may be detected by the relay apparatus 20 periodically polling the management apparatus 60.

Next, the driver management unit 24 of the relay apparatus 20 specifies the model of the image forming device 40 and the type of the OS corresponding to the newly registered punter driver (S02). For example, the driver management unit 24 specifies the model of the image forming device 40 and the type of the OS by acquiring information indicating the model of the image forming device 40 and the type of the OS from the management apparatus 60. The driver management unit 64 of the management apparatus 60 may transmit the information indicating the model of the image forming device 40 and the type of the OS to the relay apparatus 20.

If there is an image forming device 40 of the model corresponding to the printer driver that is newly registered to the management apparatus 60, out of the plural image forming devices 40 connected to the communication path Na (Yes in S03), the process proceeds to step S04. In contrast, if there is not an image forming device 40 of the model corresponding to the printer driver that is newly registered to the management apparatus 60, out of the plural image forming devices 40 connected to the communication path Na (No in S03), the process is ended. For example, the driver management unit 24 of the relay apparatus 20 checks whether or not there is an image forming device 40 of the model corresponding to the printer driver that is newly registered to the management apparatus 60, by referring to the device information stored in the storage unit 28.

In step S04, the driver management unit 24 downloads the printer driver that is newly registered to the management apparatus 60, from the management apparatus 60. The printer driver is stored in the storage unit 28. Further, driver identification information regarding the printer driver and device model information (for example, a model name) indicating the model of the image forming device 40 that is controlled by the printer driver are associated and stored in the storage unit 28.

Next, the control unit 34 of the relay apparatus 20 specifies the terminal device 50 in which the OS corresponding to the downloaded printer driver is mounted. For example, the control unit 34 specifies the terminal device 50 by referring to the terminal information stored in the storage unit 28 or the terminal device management table 30. Alternatively, the control unit 34 may specify the terminal device 50 capable of using the image forming device 40 which is controlled by the downloaded printer driver (the terminal device 50 connected to the image forming device 40) and having the OS installed therein corresponding to the printer driver, by referring to the terminal device management table 30.

When the terminal device 50 is connected to the communication path Na (Yes in S05), the notification unit 36 transmits information indicating the presence of the new printer driver to the terminal device 50 (S06). When the terminal device 50 is connected to the communication path Na (No in S05), the process is ended.

In addition, when plural new printer drivers are registered to the management apparatus 60 and the plural printer drivers are downloaded to the relay apparatus 20, the notification unit 36 transmits information indicating the presence of all of the printer drivers corresponding to the OS installed in the terminal device 50, to the terminal device 50.

The information indicating the presence of a new printer driver is displayed on the display of the terminal device 50. If the user instructs the installation of the new printer driver, by using the terminal device 50, the terminal device 50 transmits information indicating the instruction (acquisition request information) to the relay apparatus 20. The supply unit 38 of the relay apparatus 20 transmits the new printer driver to the terminal device 50 in response to the acquisition request. Thus, the new printer driver is installed in the terminal device 50. The image forming device 40 corresponding to the printer driver is controlled by the terminal device 50, using the printer driver.

In addition, in the above description, when the image forming device 40 of the model corresponding to the newly registered printer driver is connected to the communication path Na, even if the terminal device 50 in which the OS corresponding to the printer driver is mounted is not connected to the communication path Na, the driver management unit 24 downloads the printer driver (S04). Thus, when a new terminal device 50 in which the OS corresponding to the printer driver is mounted is connected to the communication path Na, the printer driver is more rapidly supplied to the terminal device 50 than in a case where the printer driver is downloaded after connection is established.

As another example, the driver management unit 24 may download the printer driver corresponding to the model of the image forming device 40 connected to the communication path Na and the type of the OS installed in the terminal device 50 connected to the communication path Na, from the management apparatus 60. In other words, the image forming device 40 of the model corresponding to the newly registered printer driver is connected to the communication path Na, when the terminal device 50 in which the OS corresponding to the newly registered printer driver is mounted is connected to the communication path N, and the driver management unit 24 may download the printer driver from the management apparatus 60. The model of the image forming device 40 corresponding to the newly registered printer driver and the type of the corresponding OS are specified in the process of step S02. The driver management unit 24 downloads the printer driver corresponding to the model of the image forming device 40 connected to the communication path Na and the OS of the terminal device 50 connected to the communication path N, from the management apparatus 60, by referring to the specified information and the information (device information and terminal information) stored in the storage unit 28.

In the present embodiment, as step S06, the information indicating the presence of the new printer driver is transmitted to the terminal device 50, and the printer driver is supplied to the terminal device 50 in response to the acquisition request from the terminal device 50. Thus, it is possible to inadvertently prevent the printer driver having, a possibility of the occurrence of a defect (bug) from being installed in the terminal device 50. Of course, the supply unit 38 may supply the printer driver to the terminal device 50 in a push manner without transmitting the information indicating the presence of a new printer driver to the terminal device 50. In this case, a new printer driver is installed in the terminal device 50 without receiving the acquisition request from the terminal device 50.

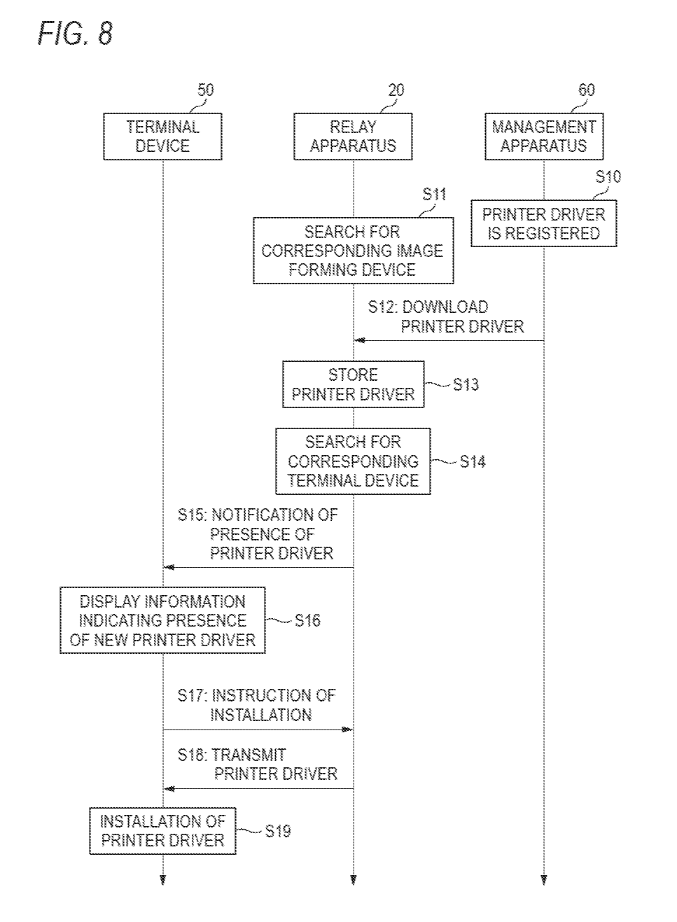

Next, the entire process of the device management system will be described with reference to FIG. 8. First, a new printer driver is registered in the management apparatus 60 (S10). As described above, the registration is detected by the driver management unit 24 of the relay apparatus 20.

If the driver management unit 24 of the relay apparatus 20 detects the registration, it searches for the image forming device 40 of the model corresponding to the printer driver which is newly registered to the management apparatus 60, out of the plural image forming devices 40 connected to the communication path Na (S11). When the image forming device 40 of the model corresponding to the newly registered printer driver is connected to the communication path Na, the driver management unit 24 of the relay apparatus 20 downloads the newly registered printer driver from the management apparatus 60 (S12). The printer driver is stored in the storage unit 28 of the relay apparatus 20 (S13).

Next, the control unit 34 searches for the terminal device 50 in which the OS corresponding to the downloaded printer driver is mounted, out of the plural terminal devices 50 connected to the communication path Na (S14). For example, the control unit 34 specifies the terminal device 50, by referring to the terminal information or the terminal device management table 30.

When the terminal device 50 is connected to the communication path Na, the notification unit 36 transmits the information indicating the presence of the new printer driver to the terminal device 50 (S15). The display of the terminal device 50 displays that the new printer driver is present (S16).

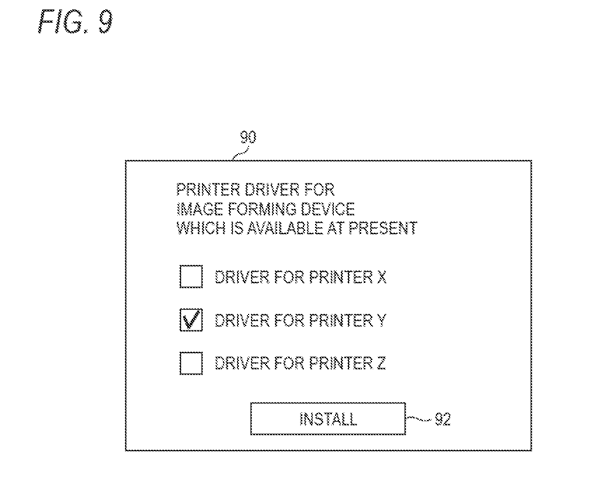

FIG. 9 displays an example of a screen 90 displayed on the terminal device 50. As an example, information indicating three types of printer drivers (a driver for a printer X, a driver for a printer Y and a driver for a printer Z) is displayed. Each printer driver is a printer driver acquired by the relay apparatus 20 that is newly registered to the management apparatus 60. Each printer driver is the printer driver corresponding to the OS of the terminal device 50. In other words, it is illustrated that three new printer drivers corresponding to the OS of the terminal device 50 are present in the relay apparatus 20. The user specifies the printer driver to be installed, by using the user interface (UI) of the terminal device 50. In the example illustrated in FIG. 9, the driver for the printer Y is designated. Then, if the user instructs installation thereof by using the UI, information for instructing the installation of the driver for the printer Y is transmitted from the terminal device 50 to the relay apparatus 20 (S17). For example, an installation instruction is given by the user pressing an installation button 92.

If the supply unit 38 of the relay apparatus 20 receives information indicating the installation instruction from the terminal device 50, the printer driver designated by the user in response to the instruction is transmitted to the terminal device 50 (S18). For example, the driver for the printer Y is transmitted from the relay apparatus 20 to the terminal device 50. Thus, the driver for the printer Y is installed in the terminal device 50 (S19).

As described above, if a new printer driver is registered to the management apparatus 60, the printer driver corresponding to the model of the image forming device 40 connected to the communication path Na is downloaded from the management apparatus 60 to the relay apparatus 20. In other words, a necessary printer driver in a local management unit 10 is downloaded in the relay apparatus 20 of the management unit 10, and an unnecessary printer driver in the management unit 10 is not downloaded. Then, information indicating the addition of the new printer driver is transmitted to the terminal device 50 in which the OS corresponding to the downloaded printer driver is mounted. Thus, information indicating the presence of the printer driver that can be used in the terminal device 50 is transmitted to the terminal device 50. Information indicating the presence of the printer driver that cannot be used in the terminal device 50 is not transmitted to the terminal device 50. The user selects a target printer driver out of a single or plural printer drivers that can be used. According to the present embodiment, the number of choices of the printer driver is reduced as compared to the case of selecting the target printer driver out of a printer driver group including the printer drivers that can be used. Thus, the selection of the printer driver by the user is facilitated. For example, there is a case which does not include a printer driver for controlling the image forming devices 40 which are not included in the management unit 10A, out of all of the printer drivers which are newly registered to the management apparatus 60. According to the present embodiment, the printer driver for controlling the image forming devices 40 which are included in the management unit 10A is supplied to the relay apparatus 20 of the management unit 10A. The printer driver for controlling the image forming devices 40 which are not included in the management unit 10A is not supplied to the relay apparatus 20 of the management unit 10A. Therefore, since the number of choices of the printer driver is reduced as compared to the case of selecting the target printer driver out of all of the newly registered printer drivers, the selection of the printer driver by the user is facilitated.

For example, it is assumed that 100 new printer drivers are registered in the management apparatus 60. Without applying the present embodiment, when information regarding all printer drivers which have been newly registered in the management apparatus 60 is displayed on the screen of the terminal device 50, 100 printer drivers are displayed. In contrast, in the present embodiment, out of the 100 printer drivers, the printer driver corresponding to the model of the image forming device 40 included in the management unit 10A is downloaded from the management apparatus 60 to the relay apparatus 20. Then, information indicating the presence of the printer driver is transmitted to the terminal device 50 having an OS installed therein corresponding to the downloaded printer driver, out of a single or plural terminal devices 50 included in the management unit 10A. For example, it is assumed that three new printer drivers are associated with the OS of a certain terminal device 50. In this case, as illustrated in FIG. 9, only three printer drivers are displayed on the terminal device 50. According to the present embodiment, in the above example, the number of choices is reduced from 100 to three, and therefore the selection of the printer driver by the user is facilitated.

For example, there is a case of storing printer drivers of plural manufacturers in the management apparatus 60. In this case, the number of stored printer drivers may be enormous. By applying the present embodiment to such a case, the number of choices of the printer driver is expected to be greatly reduced. Accordingly, the selection of the printer driver by the user is facilitated.

In addition, in the present embodiment, the relay apparatus 20 communicates with the management apparatus 60. In this case, the terminal device 50 does not directly communicate with the management apparatus 60. Of course, the terminal device 50 may directly communicate with the management apparatus 60.

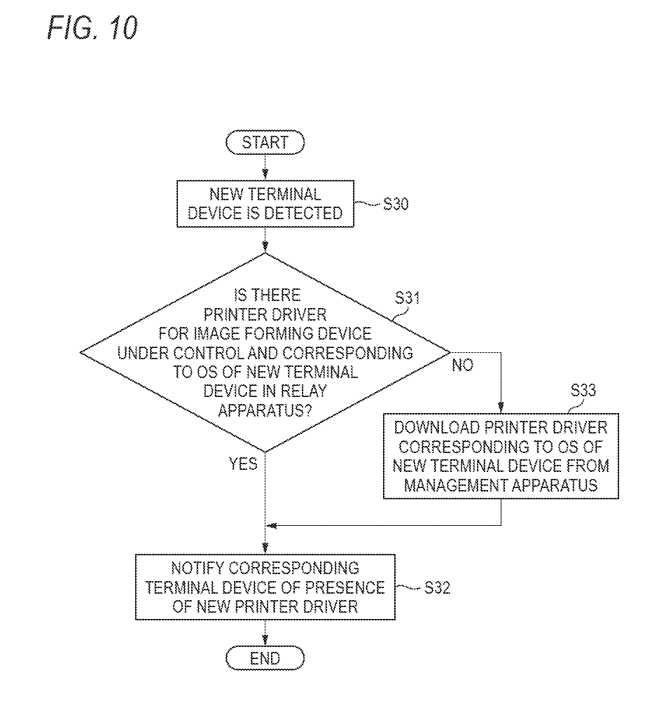

Next, the process by the relay apparatus 20 in the case where a new terminal device 50 is connected to the communication path Na will be described with reference to FIG. 10.

When the new terminal device 50 is connected to the communication path Na, the device management unit 22 detects the connection of the terminal device 50 (S30). As described above, the device management unit 22 acquires terminal information from the terminal device 50.

When the printer driver which controls the image forming device 40 connected to the communication path Na and corresponds to the OS installed in a newly detected terminal device 50 is already stored in the storage unit 28 (Yes in S31), the process proceeds to step S32. In contrast, when the printer driver is not stored in the storage unit 28 (No in S31), the process proceeds to step S33.

In step S32, the notification unit 36 transmits information indicating the presence of the corresponding printer driver to the new terminal device 50. If the acquisition request of the printer driver is transmitted from the terminal device 50, the supply unit 38 transmits the corresponding printer driver to the terminal device 50. Thus, the printer driver is installed in the new terminal device 50.

In step S33, the driver management unit 24 downloads the printer driver for the image forming device 40 connected to the communication path Na and corresponding to the OS installed in the newly detected terminal device 50, from the management apparatus 60. For example, the driver management unit 24 transmits OS information indicating the OS installed in the new terminal device 50 to the management apparatus 60. Device information regarding the image forming device 40 connected to the communication path Na is stored in the management apparatus 60. Accordingly the driver management unit 64 of the management apparatus 60 specifies the printer driver for controlling the image forming device 40 connected to the communication path Na and corresponding to the OS installed in the new terminal device 50 based on the OS information and the device information. When the specified printer driver is stored in the storage unit 66 of the management apparatus 60, the driver management unit 64 transmits the printer driver to the relay apparatus 20. Thus, the printer driver is downloaded to the relay apparatus 20. Thereafter, the process proceeds to step S32. In addition, when the printer driver which is used in the new terminal device 50 is not used management apparatus 60, the process is ended.

In this manner, even if the new terminal device 50 is connected to the communication path Na, it is in a state where the printer driver corresponding to the OS of the terminal device 50 can be transmitted to the terminal device 50.

Further, when the new image forming device 40 is connected to the communication path Na, the device management unit 22 of the relay apparatus 20 collects the device information regarding the image forming device 40 from the image forming device 40. When the printer driver corresponding to the model of the image forming device 40 is not stored in the storage unit 28 of the relay apparatus 20, the driver management unit 24 of the relay apparatus 20 acquires the printer driver from the management apparatus 60. The notification unit 36 of the relay apparatus 20 transmits information indicating the acquisition of the printer driver, to the terminal device 50 in which the OS corresponding, to the printer driver is mounted. The supply unit 38 of the relay apparatus 20 supplies the printer driver to the terminal device 50 in response to the acquisition request from the terminal device 50. Thus, the printer driver for installing the new image forming device 40 is installed in the terminal device 50. When the printer driver corresponding to the model of the image forming device 40 is stored in the storage unit 28 of the relay apparatus 20, the notification unit 36 of the relay apparatus 20 transmits information indicating the presence of the printer driver to the terminal device 50 in which the OS corresponding to the printer driver is mounted. The supply unit 38 of the relay apparatus 20 supplies the printer driver to the terminal device 50, in response to the acquisition request from the terminal device 50. Thus, the printer driver for controlling the new image forming device 40 is installed in the terminal device 50. In this manner, even when the new image forming device 40 is connected to the communication path Na, it is in a state where the printer driver for the image forming device 40 can be supplied to the terminal device 50.

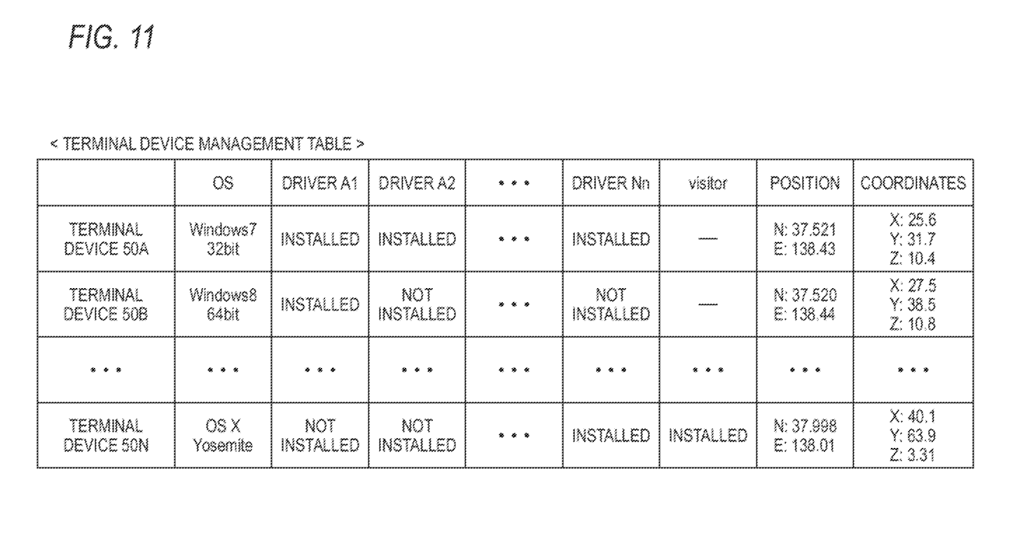

Next, a modification will be described with reference to FIG. 11. In the modification, the relay apparatus 20 notifies the terminal device 50 of guidance regarding uninstallation of the printer driver which is installed in the terminal device 50, depending on the position of the terminal device 50. Hereinafter, a specific example will be described.

The control unit 34 of the relay apparatus 20 acquires positional information regarding the terminal device 50, by using a technology such as a global positioning system (GPS), a radio frequency identifier (RFID), and iBeacon. The device management unit 22 of the relay apparatus 20 associates terminal device identification information of each terminal device 50 (for example, a terminal device ID), OS information indicating the OS stored in each terminal device 50 (for example, an OS name), driver identification information of the printer driver installed in each terminal device 50 (for example, a driver ID and name, and the like), and the positional information of each terminal device 50 with each other. The device management unit 22 generates a terminal device management table representing the association. The terminal device management table is stored in the storage unit 28.

FIG. 11 illustrates an example of the terminal device management table. For example. the OS installed in the terminal device 50A is “Windows (registered trademark) 7 (32 bit version)”. Plural printer drivers are installed in the terminal device 50A. The names of the printer drivers installed in the terminal device 50A are “driver A1”, “driver A2”, . . . , and “driver Nn”. Further, the OS installed in the terminal device 50B is “Windows (registered trademark) 8 (64 bit version)”. One printer driver is installed in the terminal device 50B. The name of the printer driver is “driver A1”. Similarly, for other terminal devices, the mounted OS and the installed printer driver are managed using a table. Further, the positional information of the terminal device 50 is included in the table. “Position” is an item representing the latitude and longitude of a position in which the terminal device 50 is provided. “Coordinate” is an item representing the three-dimensional coordinates of the terminal device 50 relative to a reference position. The reference position is a pre-set position, for example, a position that is set in the management unit 10. The reference position is set, as an example, in an office, a factory, a home or the like. Of course, the reference position may also be set outside the management unit 10.

The relay apparatus 20 communicates with the terminal device 50, and acquires terminal information from the terminal device 50. The terminal information contains OS information indicating the OS, driver identification information regarding an installed printer driver, information indicating whether or not the user of the terminal device 50 is a visitor, and the like. The notification unit 36 of the relay apparatus 20 transmits a printer driver for controlling the image forming device 40 connected to the communication path Na, out of the 28, plural printer drivers stored in the storage unit and indicating the presence of the printer driver corresponding to the OS installed in the terminal device 50, to the terminal device 50. If the acquisition request of the printer driver is transmitted from the terminal device 50, the supply unit 38 of the relay apparatus 20 transmits the printer driver corresponding to the acquisition request, to the terminal device 50. Thus, the printer driver is installed in the terminal device 50.

A specific example will be described. For example, it is assumed that the user such as a business traveler visits a certain office (for example, an area within the management unit 10A). In this case, the relay apparatus 20 of the management unit 10A communicates with the terminal device 50N that the user carries. The relay apparatus 20 acquires the terminal information from the terminal device 50N, and transmits the printer driver (for example, a printer driver Nn) to the terminal device 50N, according to the above process. Thus, the state is such that the image forming device 40 controlled by the printer driver Nn can be used by the terminal device 50N. The table illustrated in FIG. 11 represents a state after the printer driver Nu is installed in the terminal device 50N. In addition, the terminal device 50N is registered as a visitor.

The control unit 34 of the relay apparatus 20 acquires the positional information regarding the terminal device 50N. When a difference between the position of the terminal device 50N and the reference position is equal to or greater than a pre-set threshold, the control unit 34 transmits information for inquiring as to whether or not the printer driver Nn is uninstalled to the terminal device 50N. The reference position is, for example, a pre-set position, as an example, a position in an office (in the management unit 10A) under the control of the relay apparatus 20. For example, if the user moves away from the office while carrying the terminal device 50N, and the difference between the position of the terminal device 50N and the reference position is equal to or greater than the threshold, information indicating an inquiry regarding uninstallation is transmitted from the relay apparatus 20 to the terminal device 50N. The inquiry is transmitted in, for example, an e-mail.

If the user (business traveler) instructs installation of the printer driver Nn by using the terminal device 50N, the terminal device 50N uninstalls (deletes) the printer driver Nn stored in the storage unit of the terminal device 50N. When an uninstallation instruction is not given by the user, the printer driver Nn is not uninstalled.

Through the above process, an unnecessary printer driver is uninstalled. As compared to a case where the unnecessary printer driver is not uninstalled, the memory capacity of the terminal device is larger. For example, it is assumed that the punter driver for the image forming device 40 used in the office in the business trip destination is installed in the terminal device 50. In this case, the image forming device 40 is used only a few times. According to the modification, after the business trip ends, the printer driver is uninstalled. In this manner, the printer driver that is no longer necessary for the business traveler is uninstalled. In addition, if the printer driver is necessary after the uninstallation, in response to the process illustrated in FIG. 10, the printer driver may be installed in the terminal device.

In the above-described embodiment and modification, the relay apparatus 20 may acquire the printer driver from the management apparatus 60, according to the usage history of the image forming device 40. As described above, the relay apparatus 20 acquires device information from the image forming. device 40. The device information contains information indicating the usage history of the image forming device 40. The usage history is, for example, the date and time (for example, such as the print date and time) when the image forming device 40 is used, the number of outputs at the time of each use (for example, the number of prints), and the like.

The driver management unit 24 of the relay apparatus 20 acquires the printer driver of each image forming device 40 from the management apparatus 60, depending on, for example, the frequency of use of each image forming device 40, by referring to the usage history information of each image forming device 40. The frequency of use is, for example, the number of uses per a unit period of time (for example, a unit number of days). The driver management unit 24 acquires the printer driver corresponding to the image forming device 40 connected to the communication path Na and for the image forming device 40 in which the frequency of use is equal to or greater than the pre-set threshold, from the management apparatus 60. Even in the printer driver corresponding to the image forming device 40 connected to the communication path Na, the driver management unit 24 does not acquire the printer driver for the image forming device 40 in which the frequency of use is less than the threshold.

Through the above process, the printer driver for the image forming device 40 having a relatively high frequency of use is acquired by the relay apparatus 20, and information indicating that the printer driver is newly acquired is transmitted to the terminal device 50. The printer driver for the image forming device 40 having a relatively low frequency of use is not acquired by the relay apparatus 20, and information indicating the presence of the printer driver is not transmitted to the terminal device 50. Thus, since information indicating the image forming device 40 having a relatively low frequency of use is not displayed on the terminal device 50, the number of choices of the printer driver is reduced, and the selection of the printer driver by the user is further facilitated.

In the above-described embodiment and modification, the management apparatus 60 may not be equipped with the function of the relay apparatus 20. For example, the relay apparatus management unit 62 of the management apparatus 60 may acquire the terminal device information of the terminal device 50 included in the management unit 10. In this case, the device information regarding the image forming device 40 and terminal device information regarding the terminal device 50 are stored in the management apparatus 60, and the image forming device 40 and the terminal device 50 are managed by the management apparatus 60.

Further, the driver management unit 64 of the management apparatus 60 may provide the printer driver corresponding to the model of the image forming device 40 included in the management unit 10 to the relay apparatus 20 of the management unit 10, by referring to the device information. For example, if a new printer driver is registered in the management apparatus 60, the driver management unit 64 specifies the image forming device 40 of the model controlled by the printer driver, by referring to the device information, and supplies the printer driver to the relay apparatus 20 of the management unit 10 including the image forming device 40. Further, the driver management unit 64 may specify the image forming device 40 of the model controlled by the new printer driver, by referring to the device information, and may specify the terminal device 50 in which the OS corresponding to the new printer driver is mounted, by referring to the terminal information. Then, the driver management unit 64 may supply the new printer driver to the relay apparatus 20 of the management unit 10 including the specified image forming device 40 and the specified terminal device 50.

Further, the driver management unit 64 of the management apparatus 60 may supply the printer driver to the relay apparatus 20 of the management unit 10 depending on the frequency of use of the image forming device 40.

Both the relay apparatus 20 and the management apparatus 60 are realized due to cooperation of hardware resources and software, as an example. Specifically, both the relay apparatus 20 and the management apparatus 60 include a CPU which is not illustrated, and the like. The function of each part of the relay apparatus 20 and the management apparatus 60 is realized by the processor reading and executing a program stored in a storage device which is not illustrated. The program is stored in the storage device through a storage medium such as a CD or a DVD, or a communication path such as a network. Alternatively each part of the relay apparatus 20 and the management apparatus 60 may be realized by a hardware resource such as, for example, a processor or an electronic circuit. For achieving realization, a device such as a memory may be used. As another example, each part of the relay apparatus 20 and the management apparatus 60 may be realized by a digital signal processor (DSP) or a field programmable gate array (FPGA).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A device management system comprising:
a management apparatus including a first memory unit that stores a control program for controlling a management target device, for each type of the management target device; and
a relay apparatus including
an acquisition unit that acquires the control program corresponding to a type of the management target device connected to the relay apparatus from the management apparatus, and
an execution unit that executes a process for supplying the control program acquired by the acquisition unit to a control device connected to the relay apparatus the control device controlling the management target device connected to the relay apparatus.

2. The device management system according to claim 1,
wherein when a new control program corresponding to a type of the management target device connected to the relay apparatus is stored in the first memory unit, the acquisition unit acquires the new control program from the management apparatus.

3. The device management system according to claim 1,
wherein the acquisition unit acquires the control program from the management apparatus, depending on a frequency of use of the management target device connected to the relay apparatus.

4. The device management system according to claim 1,
wherein the execution unit supplies the control program acquired by the acquisition unit to the control device connected to the relay apparatus.

5. The device management system according to claim 1,
wherein the execution unit includes
a notification unit that notifies the control device connected to the relay apparatus that a new control program is acquired by the acquisition unit; and
a supply unit that supplies the new control program to the control device of a notification destination, in response to an acquisition request of the control program from the control device of the notification destination.

6. The device management system according to claim 1,
wherein the first memory unit stores the control program for each type of the management target device and for each type of a basic control program for controlling the control device, in which the basic control program is installed in the control device that controls the management target device, and
the acquisition unit acquires the control program corresponding to the type of the management target device connected to the relay apparatus, for each type of the basic control program, from the management apparatus.

7. The device management system according to claim 6,
wherein the acquisition unit acquires the control program corresponding to the type of the management target device connected to the relay apparatus and a type of a basic control program installed in the control device connected to the relay apparatus, from the management apparatus.

8. The device management system according to claim 6,
wherein when the control device having the basic control program installed therein corresponding to the control program acquired by the acquisition unit is connected to the relay apparatus, the execution unit executes the process for supplying the control program acquired by the acquisition unit to the control device.

9. The device management system according to claim 6,
wherein the relay apparatus further includes a second memory unit that stores the control program acquired by the acquisition unit, and
when a new control device is connected to the relay apparatus and a control program corresponding to a basic control program installed in the new control device is already stored in the second memory unit, the execution unit executes a process for supplying the control program to the new control device.

10. The device management system according to claim 6,
wherein the relay apparatus further includes a second memory unit that stores the control program acquired by the acquisition unit,
when a new control device is connected to the relay apparatus and a control program corresponding to a basic control program installed in the new control device is not stored in the second memory unit, the acquisition unit acquires the control program from the management apparatus, and
the execution unit executes the process for supplying the control program to the new control device.

11. The device management system according to claim 1,
wherein the relay apparatus further includes a deletion processing execution unit that executes a process for deleting the control program which is supplied to the control device, depending on a position of the control device connected to the relay apparatus.

12. The device management system according to claim 11,
wherein the deletion processing execution unit notifies the control device of a guide for deletion of the supplied control program.

13. A relay apparatus comprising:
an acquisition unit that acquires a. control prop⁻am corresponding to a type of a management target device connected to the relay apparatus, from a management apparatus that stores the control program for controlling the management target device;
a notification unit that notifies a control device that a new control program is acquired by the acquisition unit, in which the control device is connected to the relay apparatus and controls the management target device; and
a supply unit that supplies the new control program to the control device of a notification destination, in response to an acquisition request of the control program from the control device of the notification destination.

14. A relay method comprising:
acquiring a control program corresponding to a type of a management target device connected to the computer, from a management apparatus that stores a control program for controlling a management target device;
notifying a control device that a new control program is acquired, in which the control device is connected to the computer and controls the management target device; and
supplying the control program to the control device of a notification destination, in response to an acquisition request of the control program from the control device of the notification destination.

15. A non-transitory computer readable medium storing a program causing a computer to execute a process for relay in device management, the process comprising:
acquiring a control program corresponding to a type of a management target device connected to the computer, from a management apparatus that stores a control program for controlling a management target device;
notifying a control device that a new control program is acquired, in which the control device is connected to the computer and controls the management target device; and
supplying the control program to the control device of a notification destination, in response to an acquisition request of the control program from the control device of the notification destination.
